(19) United States
(12) Patent Application Publication
(10) Pub. No.: US 2009/0199174 A1
(43) Pub. Date: Aug. 6, 2009

(54) Fax number hyperlink software program product

(76) Inventor: Mina Houtan, Egg Harbor Township, NJ (US)

Correspondence Address: Mina Houtan, Ph.D., 300 Central Avenue, Egg Harbor Township, NJ, 08234, US

(21) Appl. No.: 12/012,472

(22) Filed: Feb. 4, 2008

(51) Int. Cl. G06F 17/21; G06F 9/44

(52) U.S. Cl. 717/173; 715/207

(57) ABSTRACT

Software program development has grown in huge proportions in the past several decades. With the advancements in software language structure, anyone skilled in the field of computer programming was developing new software. This improved invention will allow the user to save time by performing an everyday task in the world of business; faxing media, only this invention will improve the efficiency by how its done. It will allow the user to fax directly from their computer to a fax machine instead of having to print copies of documents and media from their computer, get up and go to another machine to fax them and then after faxing the documents—you end up having to scan them back into your computer for record purposes. By using this software program, the user will easily distinguish the fax number from the phone number on the same document.

### BACKGROUND OF THE INVENTION

1. Field of the Invention

This invention relates to a computer software program product which applies a mathematical formula or algorithm for ultimate use in a computer thereby reconfiguring a computer to perform a specific task. It will allow any 10 digit number that follows the word “fax” to highlight, change font, and underline thus becoming a hyperlink.

2. Background Computer Science

In today's age of computers and technology people are constantly coming up with new ideas to improve on computer programming that will solve real life problems. Prior to 1980, computer software development was uncontrolled by the PTO. It was a free for all until its sudden growth which eventually lead to many legal issues regarding who owned the right to call a specific software development idea their own. These legal issues were of global proportions. Although there are many case studies that have a direct affect on the changes by the PTO regarding computer software development patents, the Federal Circuits In re Lowry□ decision was a huge advancement. It supported that data structure that was particular, as it existed in a computer memory, was entitled to patentability, since storage of the data would reconfigure or impart physical change to the memory of the computer. Eventually, the U.S Patent and Trademark Office decided that computer software was a patentable product as long as the inventor adhered to specific sections of the U.S. Patent Act and the Examination Guidelines for Computer-related inventions.

An example would be—whoever invents or discovers any new and useful process, machine, manufacture, or composition of matter, or any new and useful improvements thereof, may obtain a patent, subject to the conditions and requirements of this title. (section 101 of the US Patent Act) Computer-related software program inventions must be very specific and while the inventors claims are important, there is nothing more important than the specifications of the invention which will determine its patentability under 35 U.S.C. § 101. Now, software developers and engineers alike can protect their work and decide how their work will be used.

Most software developers upon obtaining their patent will attach a warning with their software product that will inform the end user that the product cannot be reproduced. This is their way of protecting themselves from misuse of their product. A combination of math and logic. Using science and engineering to develop a computer program that will perform a specific task. In the world of computing, the programmer creates programs that solve specific problems. Using a step by step plan, these programs are created to be used in business, industry and home use.

This software program will improve on the current way we fax documents. There will be no need for ink or printers, nor hardware or extraordinary connection devices. Its purpose is to make any home user or large business more efficient while saving money in the long run. By using this program the user will distinguish between the fax number and the phone number on the same document; thereby avoiding errors when faxing.

### BRIEF SUMMARY OF THE INVENTION

This invention is a software feature that will facilitate communication and reduce human errors. The feature would cause any mention of the word “fax” and all digits following that word, in any opened document, to be written in a specific font in addition for the number to be hyperlinked to a fax software. This feature can be implemented in two different ways. First, within any commercially available word processors such as Microsoft Word, or Email utility such as Lotus Notes or Microsoft Outlook, the word fax and the number following it would have a default font and the number would be hyperlinked.

The second way to implement the feature is to embed it in specialized and proprietary software that would be available off the shelf. When this software program is installed on a computer, it will hyperlink any 10 digit number following the word (fax) within any document on the computer as well as changing the font. Clicking on the hyperlink will be invoking the fax utility available on the computer. The user's potential error will be eliminated as the fax number would have a different look and feel from a phone number in the same document, thus reducing the chance of mistaking one for another.

### DETAILED DESCRIPTION OF THE INVENTION

This software program product will improve on the way we fax documents today. Once the user downloads this software program product into their computer, the user will be prompted to set up a facsimile cover page by answering a few simple questions such as their name, telephone number, fax number, and such. The way the software works is that while user is on their computer typing in any document program, it will hyperlink any 10 digit number that follows the word fax. It will highlight the number, underline it, and change the font of it. Once you click on the hyperlink, another window opens which will resemble a fax cover sheet. On this sheet you will type in the recipient's name. The users' information; such as name and fax number will be automatically entered based on the information that was used to set up the program.

Once you are ready to fax, you will be prompted to type a message to the recipient just like you would using email. You will then click on the attachment button and begin attaching documents, folders, photographs, or other media from your computer directly to a 10 digit fax number anywhere. In today's busy business environment; quickly becoming paperless, there is much time being wasted going back and forth to the fax machine to send documents that are already stored on your computer. Currently, these documents have to be printed to be made ready for faxing; wasting paper and printer ink. With this new invention, there is no need for paper or ink, you simply install this computer software program product into a computer and it's ready to go.

This software program product will transmit the faxed information via the users' current internet connection. There will be no additional hardware required to use it.

The following steps are the manner in which this program should be written and which are written in the simplest of terms.
Any 10 digit number followed by the word fax which is typed into any document program on the users' computer such as Word or Excel will underline, change color, and change font—becoming a hyperlink, distinguishing the fax number from a phone number on the same document.
Once the 10 digit number is hyperlinked, it is ready to use when clicked on. It will automatically open a folder which will look similar to a fax cover sheet.
The user will be prompted during first time use only, to fill in the required data such as their name, telephone number, fax number, company, etc. . . . This information will automatically appear on all fax cover sheets going forward.
A pop-up will appear asking the user if they want to attach the current document they are working on.
If yes is answered the current document will be automatically be attached to the cover sheet that was created and the document will be transmitted once the user clicks on the send button.
If the user clicks no, they will be prompted to click on an attachment button and a browser window will appear so that the user will be allowed to attach any other document from their computer. There will be no limit to the number of attachments in any facsimile.
Once a document is attached, a pop-up will continue to appear asking the user if there are any more documents to be sent. Once all documents are ready, the user will click on the send button.
Upon completion of faxing, you will receive a confirmation from the recipients fax machine and the final pop-up will appear asking the user if they would like to store the current facsimile in the fax file or if they would like it sent to the recycle bin. Using this software program, the use will easily distinguish the fax number from the phone number on the same document, reducing any possibility of error when faxing.

1. This invention is a software feature to be used when operating a computer. This feature may be part of commercially available Word Processors, email Utilities or it can be a standalone software purchasable off the shelf. This feature hyperlinks any ten digit number which follows the word fax (i.e. fax 012-345-6789) that a user types into any document. In other words it will highlight the number, underline it, and change the font allowing the user to visually distinguish the fax number from a phone number and consequently by clicking on the hyperlink the user will initiate sending documents, photographs, or other media from their computer directly to any standard fax machine.

2. The computer software program product from claim number one can be downloaded into any computer or notebook with a CD drive.

3. The computer software program product from claim number two will automatically highlight, underline, and change the font of any ten digit number following the word (fax).

4. The computer software program product from claim number three will be compatible with all computer operating systems.

5. The computer software program product from claim number four will replace the need for any hardware.

6. The computer software program product from claim number five will be available on a computer readable medium.

7. The software program product of claim number six will be made available for use in private, business, or industry.
